(19) United States
(12) Patent Application Publication
(10) Pub. No.: US 2012/0250782 A1
(43) Pub. Date: Oct. 4, 2012

(54) DATA TRANSMISSION SYSTEM AND METHOD

(75) Inventors: Yen-Wen CHEN, Taoyuan County (TW); I-Hsuan PENG, Taoyuan County (TW)

(73) Assignee: National Central University, Taoyuan County (TW)

(21) Appl. No.: 13/166,753

(22) Filed: Jun. 22, 2011

(30) Foreign Application Priority Data
Apr. 1, 2011 (TW) 100111602

(51) Int. Cl. H04L 27/00

(52) U.S. Cl. 375/295

(57) ABSTRACT

A data transmission system includes a mobile originated device and at least one cloud server. The mobile originated device obtains information of at least one datum to be transmitted. The mobile originated device builds connections with several candidate mobile devices through a first wireless data transmission interface, and selects at least one target mobile device from the candidate mobile devices. The mobile originated device obtains target-mobile-device information of the target mobile device through the first wireless data transmission interface. The mobile originated device transmits the target-mobile-device information and the information of the datum to be transmitted to the cloud server through a second wireless data transmission interface. The cloud server assists the mobile originated device to transmit the datum to be transmitted to the target mobile device according to the target-mobile-device information and the information of the datum to be transmitted.

### RELATED APPLICATIONS

This application claims priority to Taiwan Application Serial Number 100111602, filed Apr. 1, 2011, which is herein incorporated by reference.

### BACKGROUND

1. Technical Field

The present invention relates to a data transmission system and method. More particularly, the present invention relates to a data transmission system and method applying for mobile devices.

2. Description of Related Art

As 3C (Computer, Communications and Consumer) technology develops, there are more and more people utilizing mobile electrical devices in their daily life. Most common mobile electrical devices are personal digital assistants (PDA), mobile phones, smart phones etc. Since mobile electrical devices are designed much smaller and easy to carry, more and more people use mobile electrical devices and more functions are developed for different users.

To transmit data between electrical devices, different wireless data transmission interface (such as Bluetooth, IrDA, 802.11 series, WiFi, Zigbee etc.) are developed. Since wireless transmission interfaces are not restricted by length of physical transmission wires, many mobile electrical devices are designed with wireless transmission interface supported.

Due to limited size and battery life, processing ability of mobile electrical devices is not very good. As a result, mobile electrical devices need more time to transmit or process files, and may not execute files fluently.

### SUMMARY

According to one embodiment of this invention, a data transmission system is provided. A mobile originated device of the data transmission system obtains information of the target mobile device and transmits the datum to be transmitted to the target mobile device with assistance of the cloud server. The data transmission system includes a first wireless data transmission interface, a second wireless data transmission interface, a mobile originated device and at least one cloud server. The mobile originated device includes a processing unit. The processing unit includes a first obtaining module, a selecting module, a second obtaining module and an information transmitting module. The first obtaining module obtains information of at least one datum to be transmitted. The selecting module builds connections with several candidate mobile devices through the first wireless data transmission interface, and selects at least one target mobile device from the candidate mobile devices. The second obtaining module obtains target-mobile-device information of the target mobile device through the first wireless data transmission interface. The information transmitting module transmits the target-mobile-device information and the information of the datum to be transmitted. The cloud server includes a cloud-computing device. A connection-building module of the cloud-computing device builds connections with the mobile originated device through the second wireless data transmission interface. The connection-building module receives the target-mobile-device information and the information of the datum to be transmitted. The connection-building module assists the mobile originated device to transmit the datum to be transmitted to the target mobile device according to the target-mobile-device information and the information of the datum to be transmitted.

According to another embodiment of this invention, a data transmission method is provided to obtain information of the target mobile device and transmits the datum to be transmitted to the target mobile device from the mobile originated device with assistance of the cloud server. The data transmission method may take the form of a computer program product stored on a computer-readable storage medium having computer-readable instructions embodied in the medium. The data transmission method includes the following steps: information of at least one datum to be transmitted is obtained. At least one target mobile device is selected from the candidate mobile devices. Target-mobile-device information of the target mobile device is obtained. A mobile originated device transmits the target-mobile-device information and the information of the datum to be transmitted to a cloud server through a wireless data transmission interface. The cloud server assists the mobile originated device to transmit the datum to be transmitted to the target mobile device according to the target-mobile-device information and the information of the datum to be transmitted.

Above all, the resource of the mobile originated device for data transmission or pre-processing can be saved with assistance of the cloud server. Besides, since the datum is pre-processed according to the information of the target mobile device, the target mobile device can execute the pre-processed datum fluently.

These and other features, aspects, and advantages of the present invention will become better understood with reference to the following description and appended claims. It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiments, with reference made to the accompanying drawings as follows:

FIG. 1 is a block diagram of a data transmission system according to one embodiment of this invention;

FIG. 2 illustrates an embodiment of the data transmission system;

FIG. 3 is another embodiment of the data transmission system;

FIG. 4 is a flow diagram of a data transmission method according to another embodiment of this invention; and

FIG. 5 is an embodiment of selecting at least one target mobile device from the candidate mobile devices (step 720).

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

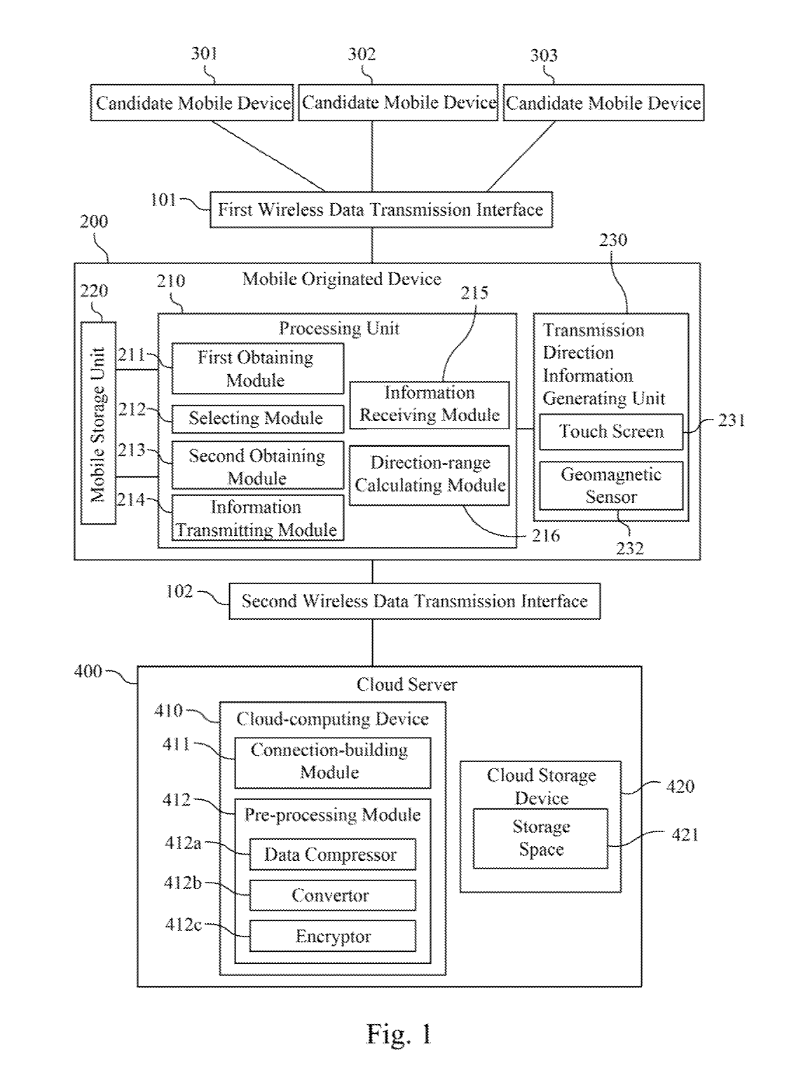

FIG. 1 is a block diagram of a data transmission system according to one embodiment of this invention. A mobile originated device of the data transmission system obtains information of the target mobile device and transmits the datum to be transmitted to the target mobile device with assistance of the cloud server.

The data transmission system includes a first wireless data transmission interface 101, a second wireless data transmission interface 102, a mobile originated device 200 and at least one cloud server 400. The first wireless data transmission interface 101 and the second wireless data transmission interface 102 may utilize IEEE 802.11 series, WiFi, Zigbee, second-generation (2G) wireless telephone technology, third-generation wireless telephone technology (3G), Worldwide Interoperability for Microwave Access (WiMAX), Beyond 3G (B3G), Long Term Evolution (LTE) or any other middle or long distance wireless communication technology for data transmission. In addition, Bluetooth, Infrared Data (IrDA) Association or any other short distance wireless communication technology may also be utilized by the first wireless data transmission interface 101 for data transmission.

The mobile originated device 200 includes a processing unit 210. The processing unit 210 includes a first obtaining module 211, a selecting module 212, a second obtaining module 213 and an information transmitting module 214. The first obtaining module 211 obtains information of at least one datum to be transmitted. The datum to be transmitted may be a file, a telephone number, an email address, a text message, a multimedia message or any other type of datum. In one embodiment of this invention, the mobile originated device 200 may further include a mobile storage unit 220, which is electrically connected with the processing unit 210. The mobile storage unit 220 stores at least one candidate datum, from which the first obtaining module 211 selects the datum to be transmitted and generates the corresponding information of the datum to be transmitted. In another embodiment of this invention, the first obtaining module 211 may select the datum to be transmitted from candidate datums stored in a cloud storage device 420 of the cloud server 400, and obtain the information of the selected datum to be transmitted, such as storage location or file name of the selected datum to be transmitted.

The selecting module 212 builds connections with several candidate mobile devices 301 [symbol] 302 [symbol] 303 through the first wireless data transmission interface 101, and selects at least one target mobile device from the candidate mobile devices 301 [symbol] 302 [symbol] 303. The second obtaining module 213 obtains target-mobile-device information of the target mobile device through the first wireless data transmission interface 101. Wherein, the target-mobile-device information of the target mobile device may include at least one supported compression format, present bandwidth, at least one supported data format, a cloud identification account, hardware capability, Internet Protocol (IP) address or any other information of the target mobile device. The information transmitting module 214 transmits the target-mobile-device information and the information of the datum to be transmitted to the cloud server 400 through the second wireless data transmission interface 102.

The cloud server 400 includes a cloud-computing device 410. A connection-building module 411 of the cloud-computing device 410 builds connections with the mobile originated device 200 through the second wireless data transmission interface 102. The connection-building module 411 receives the target-mobile-device information and the information of the datum to be transmitted. The connection-building module 410 assists the mobile originated device 200 to transmit the datum to be transmitted to the target mobile device according to the target-mobile-device information and the information of the datum to be transmitted. Therefore, the resource of the mobile originated device 200 for data transmission can be saved with assistance of the cloud server 400.

In addition, the cloud-computing device 410 may further include a pre-processing module 412 to pre-process the datum to be transmitted according to the target-mobile-device information. Then, the pre-processing module 412 drives the mobile originated device 200 to transmit the pre-processed datum to the target mobile device. Therefore, the resource of the mobile originated device 200 for pre-processing can be saved with assistance of the cloud server 400. In addition, since the cloud server 400 pre-processes the datum to be transmitted according to the information of the target mobile device, the target mobile device can execute the pre-processed datum fluently.

The cloud server may compress the datum to be transmitted for pre-processing. Hence, the pre-processing module 412 may include a data compressor 412a. In one embodiment of this invention, the data compressor 412a compresses the datum to be transmitted according to the supported compression format to pre-process the datum to be transmitted. Therefore, the pre-processed (compressed) datum can be executed by the target mobile device, and the bandwidth for transmitting the pre-processed (compressed) datum can be reduced. In another embodiment of this invention, the data compressor 412a may compress the datum to be transmitted with proper compression ratio according to the present bandwidth. Therefore, the compressed datum can be transmitted without much transmission delay utilizing the present bandwidth. Especially, when the datum to be transmitted is real-time multimedia data, the bandwidth for transmission can be saved, which can make the real-time multimedia data being played fluently. Besides, the processing ability of the cloud-computing device 410 is much better than that of the mobile originated device 200, which can provide better ability to compress the real-time multimedia data without significant delay.

In addition, the cloud server 400 may convert the data format of the datum to be transmitted for pre-processing. Hence, the pre-processing module 412 may further include a convertor 412b. The convertor 412b converts the datum to be transmitted according to the supported data format to pre-process the datum to be transmitted. Therefore, the target mobile device can execute the converted datum. In addition, the datum to be transmitted is converted by the cloud-computing device 410, the processing ability of which is much better than that of the mobile originated device 200. Therefore, the conversion time can be reduced. Besides, the power of the mobile originated device 200 utilized for format conversion can be saved. Therefore, the battery life of the mobile originated device 200 can be expanded when the mobile originated device 200 is power-supplied by the battery.

Besides, the cloud server 400 may encrypt the datum to be transmitted for pre-processing. Hence, the pre-processing module 412 may further include an encryptor 412c. The encryptor 412c encrypts the datum to be transmitted according to the target-mobile-device information (such as the encryption key of the target mobile device). Therefore, the datum to be transmitted is encrypted by the cloud-computing device 410, the processing ability of which is much better than that of the mobile originated device 200. Hence, the encryption time can be saved. Besides, the power of the mobile originated device 200 utilized for encryption can be saved. Therefore, the battery life of the mobile originated device 200 can be expanded when the mobile originated device 200 is power-supplied by the battery. In other embodiments, the pre-processing module 412 may do other pre-processing to the datum to be transmitted, which should not be limited in this disclosure.

In one embodiment of this invention, the datum to be transmitted may be stored in the cloud server 400 and be transmitted from the mobile originated device 200 to the target mobile device directly. Hence, the mobile originated device 200 may receive the datum to be transmitted from the cloud server 400 through the second wireless data transmission interface 102. Then, the mobile originated device 200 may transmit the received datum to be transmitted to the target mobile device through the first wireless data transmission interface 101.

In another embodiment of this invention, the datum to be transmitted may be stored in a storage space corresponding to the cloud identification account of the target mobile device. Hence, the cloud storage device may include a storage space 421 corresponding to the cloud identification account of the target mobile device. The datum to be transmitted may be stored in the storage space 421 corresponding to the cloud identification account of the target mobile device. Then, the target mobile device may utilize its cloud identification account to obtain the datum to be transmitted from the storage space 421. Therefore, the bandwidth of the mobile originated device 200 for data transmission can be saved.

In another embodiment of this invention, the datum to be transmitted may be transmitted directly from the cloud server 400. Hence, the cloud server 400 may build connections with the target mobile device according to the target-mobile-device information (such as the IP address or the cloud identification account of the target mobile device) through the wireless data transmission interface (such as the second wireless data transmission interface 102 or any other wireless data transmission interface). Then, the cloud server transmits the datum to be transmitted to the target mobile device to assist data transmission. Therefore, the bandwidth for replying the datum to be transmitted from the cloud server 400 to the mobile originated device 200 can be saved. Besides, the bandwidth for transmitting the datum to be transmitted from the mobile originated device 200 to the target mobile device can also be saved.

Besides, the mobile originated device 200 can select the candidate mobile device within the direction range to be taken as the target mobile device. Hence, the mobile originated device 200 may further include a transmission direction information generating unit 230, which is electrically connected with the processing unit 210. The processing unit 210 may further include an information receiving module 215 and a direction-range calculating module 216. Transmission direction information is generated through the transmission direction information generating unit 230. Information receiving module 215 receives candidate-mobile-device information of the candidate mobile devices 301, 302, 303 from the candidate mobile devices 301, 302, 303 through the first wireless data transmission interface 101. The candidate-mobile-device information of the candidate devices 301, 302, 303 may include candidate device position of the candidate devices 301, 302, 303, heading direction of the candidate devices 301, 302, 303 or other types of candidate-mobile-device information of the candidate devices 301, 302, 303.

The direction-range calculating module 216 calculates transmission direction range according to the transmission direction information. Then, the selecting module 212 may select at least one of the candidate mobile devices 301 [symbol] 302 [symbol] 303, the candidate-mobile-device information of which matches the transmission direction range, to be taken as the target mobile device. Therefore, the user of the mobile originated device 200 can transmit data according to the corresponding direction of the target mobile device but without realizing the identification name or the network address of the target mobile device, which can provide an easy way for users to transmit data.

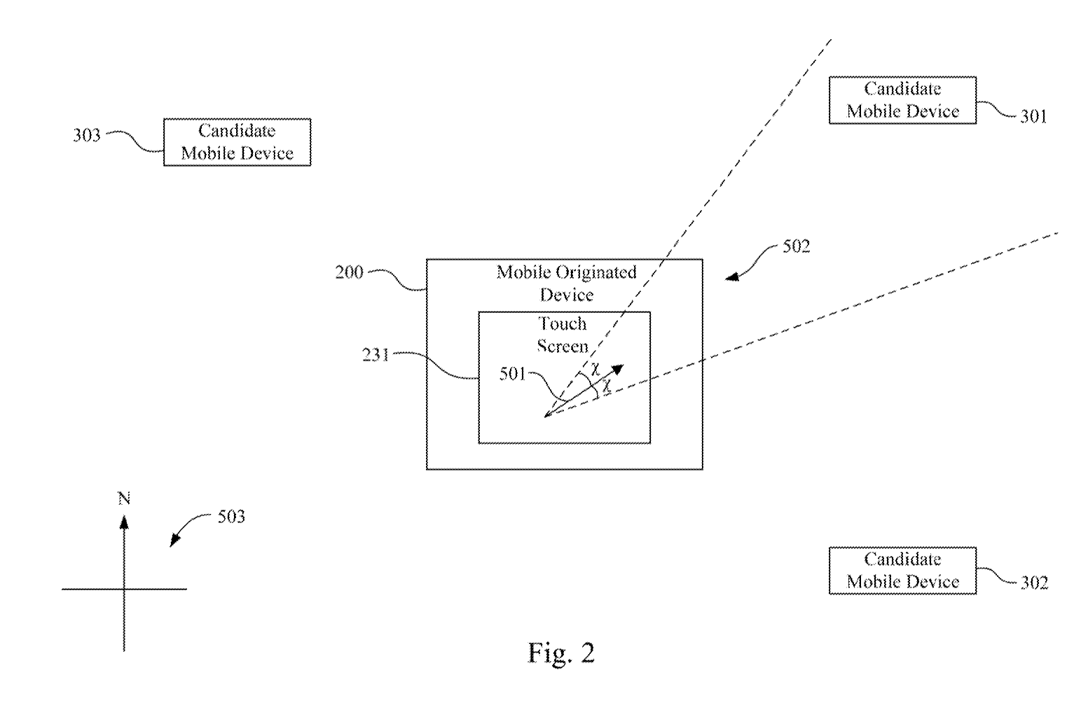

The transmission direction information generating unit 230 may include a touch screen 231 and a geomagnetic sensor 232. The touch screen 231 senses at least one touched track. The geomagnetic sensor 232 senses present geomagnetic direction relative to the mobile originated device 200. Wherein, the geomagnetic sensor 232 may be a digital compass or other types of geomagnetic sensor. Hence, the transmission direction information includes information of the at least one touched track and the present geomagnetic direction relative to the mobile originated device 200. The direction-range calculating module 216 calculates the direction of the at least one touched track, according to the present geomagnetic direction relative to the mobile originated device 200. FIG. 2 illustrates an embodiment of the data transmission system. Refer to both FIG. 1 and FIG. 2. The touch screen 231 senses a touched track 501. The geomagnetic sensor 232 senses present geomagnetic direction 503 relative to the mobile originated device 200. The direction-range calculating module 216 calculates range 502 on the direction of the touched track 501 within the direction deviation x according to the present geomagnetic direction 503 relative to the mobile originated device 200, and the calculated range 502 is taken as the transmission direction range 502. The processing unit 210 can determine if the candidate device positions of the candidate devices 301 [symbol] 302 [symbol] 303 relative to the mobile originated device 200 matches the transmission direction range 502. Hence, in this embodiment, the selecting module 212 selects the candidate devices 301, the candidate device position of which matches the transmission direction range 502, to be taken as the target mobile device. Therefore, users can touch a track toward the target mobile device on the touch screen 231 of the mobile originated device 200 to transmit data. In other words, the user of the mobile originated device 200 can transmit data easily without knowing ID or IP address of the target mobile device.

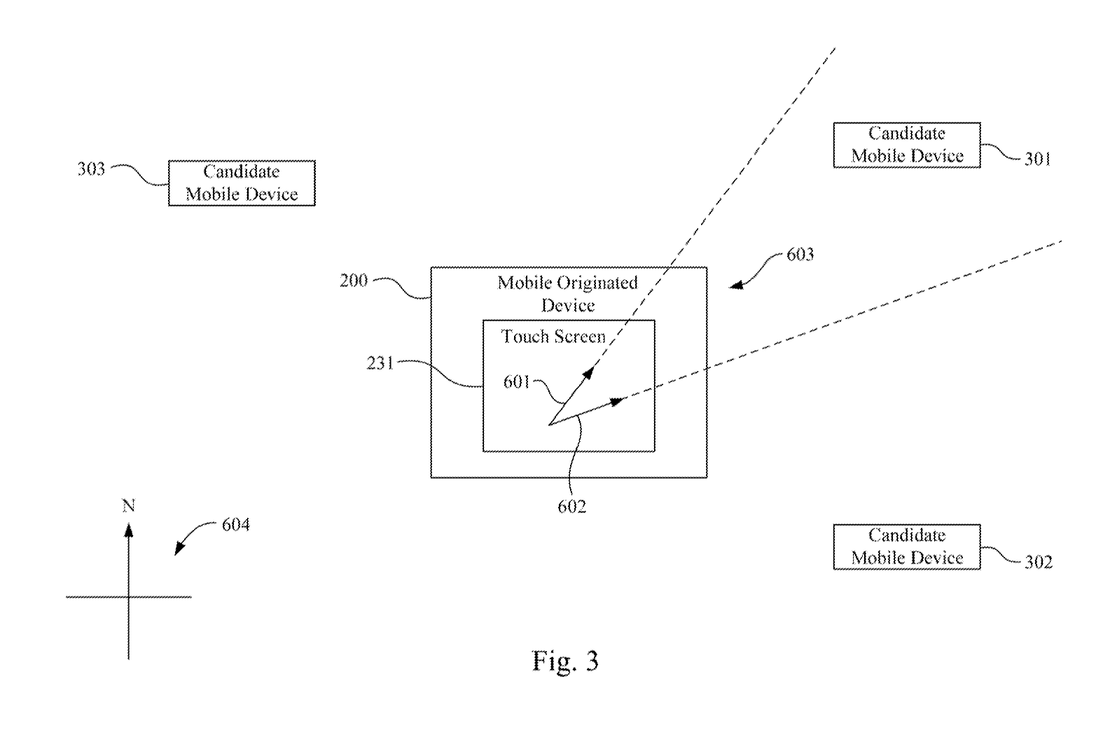

FIG. 3 is another embodiment of the data transmission system. Refer to both FIG. 1 and FIG. 3. The touch screen 231 senses two touched tracks 601, 602. The geomagnetic sensor 232 senses present geomagnetic direction 604 relative to the mobile originated device 200. The direction-range calculating module 216 calculates range 603 included between the directions of the two touched tracks 601, 602 according to the present geomagnetic direction 604 relative to the mobile originated device 200, and the calculated range 603 is taken as the transmission direction range 603. The processing unit 210 can determine if the candidate device positions of the candidate devices 301, 302, 303 relative to the mobile originated device 200 matches the transmission direction range 603. Hence, in this embodiment, the selecting module 212 selects the candidate device 301, the candidate device position of which matches the transmission direction range 603. The selected candidate device 301 is taken as the target mobile device 301. Therefore, users can touch two tracks 601, 602, which include the transmission target device 301, on the touch screen 231 of the mobile originated device 200 to transmit data. In other words, the user of the mobile originated device 200 can transmit information easily without knowing ID or IP address of the target mobile device.

In another embodiment of this invention, the transmission direction information generating unit 230 may include a direction input unit and a geomagnetic sensor. The direction input unit may be a direction key, a sound control element, a g-sensor, a gyroscope or any other direction input unit, for user to input transmission direction through thereof. The geomagnetic sensor senses present geomagnetic direction relative to the mobile originated device 200. Hence, the transmission direction information includes information of the transmission direction and the present geomagnetic direction relative to the mobile originated device 200. The direction-range calculating module 216 calculates the transmission direction range according to the transmission direction and the present geomagnetic direction relative to the mobile originated device 200. Therefore, users can input the direction of the transmission target device relative to the mobile originated device 200 to transmit data. In other words, the user of the mobile originated device 200 can transmit data easily without knowing ID or IP address of the target mobile device.

In another embodiment of this invention, the transmission direction information generating unit 230 may include a direction input unit and a geomagnetic sensor, and each of the device information generating unit of the candidate device 301, 302, 303 includes a heading direction sensor respectively. Users can input transmission direction through the direction input unit of the mobile originated device 200. The heading direction sensors of the candidate device 301, 302, 303 sense heading directions of the candidate devices 301, 302, 303 respectively. The heading direction sensors of the candidate devices 301, 302, 303 may include digital compasses or other elements, which can senses heading directions. The processing unit 210 calculates heading direction of the mobile originated device 200 according to the transmission direction and the present geomagnetic direction relative to the mobile originated device 200. Then, the processing unit 210 selects at least one of the candidate devices 301, 302, 303, heading direction of which corresponds to the heading direction of the mobile originated device 200, and the selected at least one candidate device is taken as the at least one target mobile device. For example, if a user of the mobile originated device 200 input a heading direction “North East” through the direction input unit of the mobile originated device 200, the mobile originated device 200 may transmit the information to be transmitted to at least one of the candidate devices 301, 302, 303, heading direction of which is “South West”, which corresponds to the input heading direction “North East”. Therefore, even if the position of the mobile originated device 200 or the candidate devices 301, 302, 303 can't be obtained, the information can still be transmitted according to the heading direction.

In another embodiment of this invention, the user of the mobile originated device 200 can select the target mobile device through a user interface (such as a keyboard, a mouse, a Graphical User Interface or any other type of user interface) to drive the selecting module 212 to select the target mobile device. In other embodiments, the selecting module 212 can select the target mobile device through other method, which should not be limited in this disclosure.

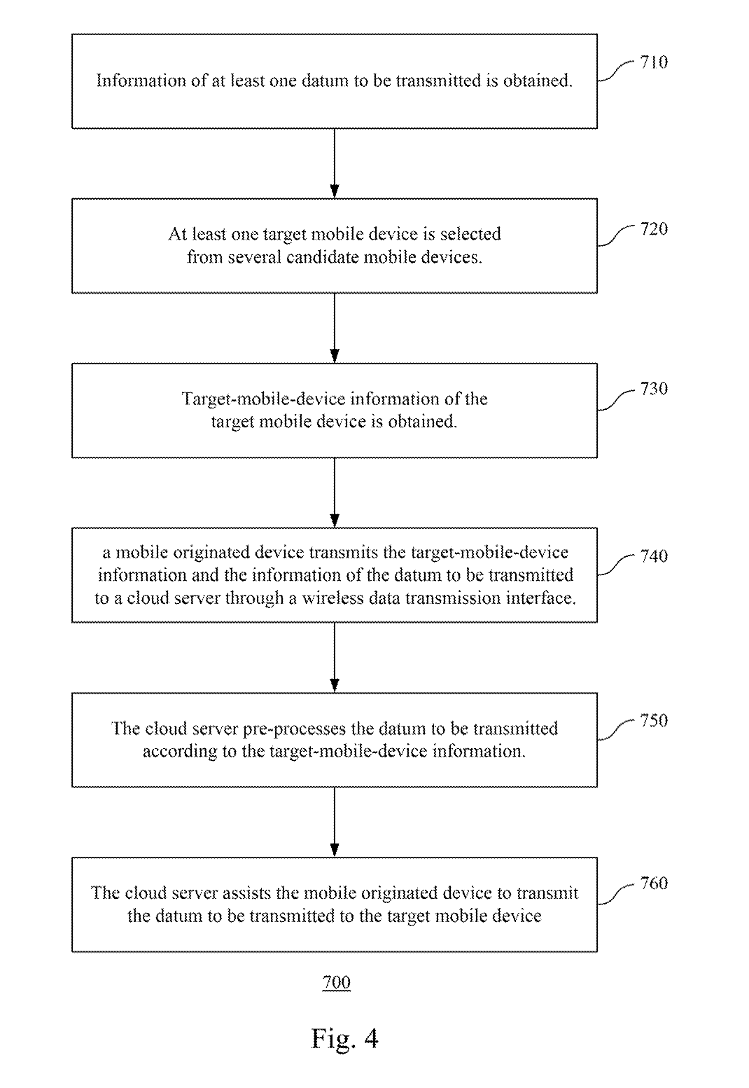

FIG. 4 is a flow diagram of a data transmission method according to another embodiment of this invention. The data transmission method obtains information of the target mobile device and transmits the datum to be transmitted to the target mobile device from the mobile originated device with assistance of the cloud server. The data transmission method may take the form of a computer program product stored on a computer-readable storage medium having computer-readable instructions embodied in the medium. Any suitable storage medium may be used including non-volatile memory such as read only memory (ROM), programmable read only memory (PROM), erasable programmable read only memory (EPROM), and electrically erasable programmable read only memory (EEPROM) devices; volatile memory such as SRAM, DRAM, and DDR-RAM; optical storage devices such as CD-ROMs and DVD-ROMs; and magnetic storage devices such as hard disk drives and floppy disk drives.

The data transmission method 700 includes the following steps:

In step 710, information of at least one datum to be transmitted is obtained. The datum to be transmitted may be a file, a telephone number, an email address, a text message, a multimedia message or any other type of datum. The mobile originated device may include a mobile storage unit to stores at least one candidate datum. Hence, in one embodiment of this invention, the datum to be transmitted can be selected from the candidate datum stored in the mobile storage unit, and the corresponding information of the datum to be transmitted can be generated according to the selection result and obtained by step 710. In another embodiment of this invention, the datum to be transmitted can be selected from candidate datums stored in the cloud storage device of the cloud server, and the information of the selected datum to be transmitted, such as storage location or file name of the selected datum to be transmitted, can be obtained (step 710).

In step 720, at least one target mobile device is selected from the candidate mobile devices.

In step 730, target-mobile-device information of the target mobile device is obtained. Wherein, the target-mobile-device information of the target mobile device may include at least one supported compression format, present bandwidth, at least one supported data format, a cloud identification account, hardware capability, Internet Protocol (IP) address or any other information of the target mobile device.

In step 740, a mobile originated device transmits the target-mobile-device information and the information of the datum to be transmitted to a cloud server through a wireless data transmission interface. Wherein, the wireless data transmission interface may follow IEEE 802.11 series, WiFi, Zigbee, 2G, 3G, WiMAX, B3G, LTE or any other middle or long distance wireless data transmission technology.

In step 760, the cloud server assists the mobile originated device to transmit the datum to be transmitted to the target mobile device according to the target-mobile-device information and the information of the datum to be transmitted. Therefore, the resource of the mobile originated device for data transmission can be saved with assistance of the cloud server.

In addition, before step 760, the cloud server may pre-process the datum to be transmitted according to the target-mobile-device information (step 750), such that the cloud server assists the mobile originated device to transmit the pre-processed datum to be transmitted to the target mobile device (step 760). Therefore, the resource of the mobile originated device for pre-processing can be saved with assistance of the cloud server. In addition, since the cloud server pre-processes the datum to be transmitted according to the information of the target mobile device, the target mobile device can execute the pre-processed datum fluently.

In one embodiment of this invention, the cloud server may compress the datum to be transmitted for pre-processing in step 750. Hence, the pre-processing of step 750 may include: the datum to be transmitted is compressed according to the target-mobile-device information, such as at least one supported compression format of the target mobile device or a present bandwidth of the target mobile device. Therefore, the target mobile device can execute the pre-processed (compressed) datum, and the bandwidth for transmitting the pre-processed (compressed) datum can be reduced. Especially, when the datum to be transmitted is real-time multimedia data, the bandwidth for transmission can be saved, which can make the real-time multimedia data being played fluently. Besides, the processing ability of the cloud-computing device is much better than that of the mobile originated device, which can provide better ability to compress the real-time multimedia data without significant delay.

In another embodiment of this invention, the cloud server may convert the data format of the datum to be transmitted for pre-processing in step 750. Hence, the pre-processing of step 750 may include: the data format of the datum to be transmitted is converted according to the supported data format of the target mobile device. Therefore, the target mobile device can execute the converted datum. In addition, the datum to be transmitted is converted by the cloud server, the processing ability of which is much better than that of the mobile originated device. Therefore, the conversion time can be reduced. Besides, the power of the mobile originated device utilized for format conversion can be saved. Therefore, the battery life of the mobile originated device can be expanded when the mobile originated device is power-supplied by the battery.

In another embodiment of this invention, the cloud server may encrypt the datum to be transmitted for pre-processing in step 750. Hence, the pre-processing of step 750 may include: the datum to be transmitted is encrypted according to the target-mobile-device information, such as the encryption key of the target mobile device. Therefore, the datum to be transmitted is encrypted by the cloud server, the processing ability of which is much better than that of the mobile originated device. Hence, the encryption time can be saved. Besides, the power of the mobile originated device utilized for encryption can be saved. Therefore, the battery life of the mobile originated device can be expanded. In other embodiments, other pre-processing method can be utilized to pre-process the datum to be transmitted (step 750), which should not be limited in this disclosure.

In one embodiment of step 760, the datum to be transmitted stored in the cloud server can be transmitted to the target mobile device directly. Hence, step 760 may include the following steps: the mobile originated device obtains the datum to be transmitted from the cloud server through the wireless data transmission interface according to the information of the datum to be transmitted. The mobile originated device transmits the datum to be transmitted to the target mobile device through the wireless data transmission interface or another wireless data transmission interface.

In another embodiment of step 760, the datum to be transmitted may be stored in a storage space corresponding to the cloud identification account of the target mobile device. Hence, the cloud storage device may include a storage space corresponding to the cloud identification account of the target mobile device. Step 760 may include the following steps: the datum to be transmitted is stored into the storage space corresponding to the cloud identification account. Then, the target mobile device can obtain the datum to be transmitted from the storage space utilizing the cloud identification account. Therefore, the bandwidth of the mobile originated device for data transmission can be saved.

In another embodiment of step 760, the datum to be transmitted may be transmitted directly from the cloud server. Hence, step 760 may include the following steps: the cloud server builds connections with the target mobile device according to the target-mobile-device information (such as the IP address or the cloud identification account of the target mobile device). Then, the cloud server transmits the datum to be transmitted to the target mobile device to assist data transmission. Therefore, the bandwidth for replying the datum to be transmitted from the cloud server to the mobile originated device can be saved. Besides, the bandwidth for transmitting the datum to be transmitted from the mobile originated device to the target mobile device can also be saved.

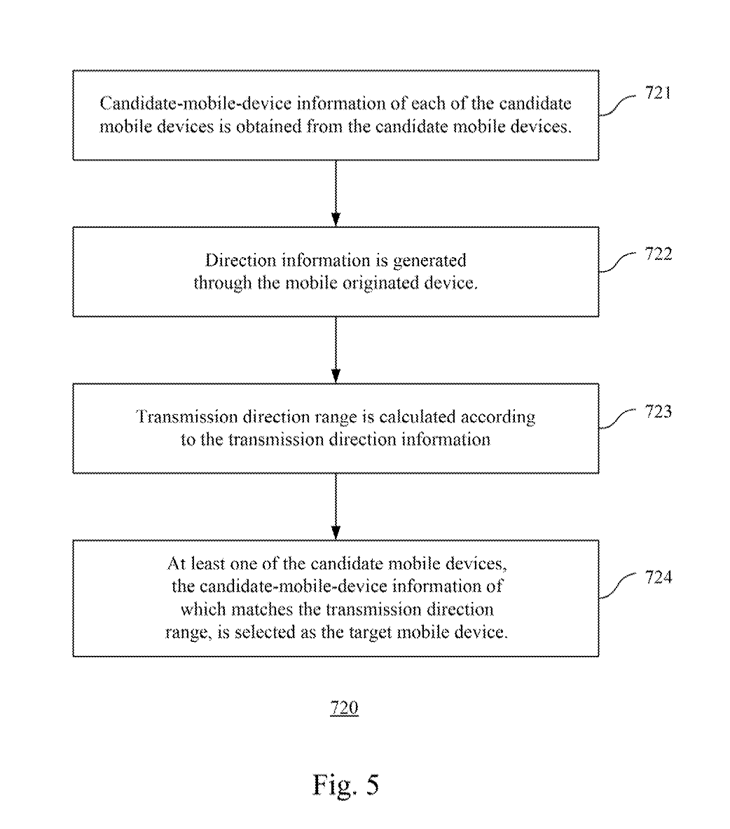

Besides, in one embodiment of step 720, the candidate mobile device within the direction range can be selected as the target mobile device. FIG. 5 is an embodiment of selecting at least one target mobile device from the candidate mobile devices (step 720). Step 720 may include the following steps:

In step 721, candidate-mobile-device information of each of the candidate mobile devices is obtained from the candidate mobile devices. The candidate-mobile-device information of the candidate devices may include candidate device position of the candidate devices, heading direction of the candidate devices or other types of candidate-mobile-device information of the candidate devices.

In step 722, direction information is generated through the mobile originated device.

In step 723, transmission direction range is calculated according to the transmission direction information.

In step 724, at least one of the candidate mobile devices, the candidate-mobile-device information of which matches the transmission direction range, is selected as the target mobile device. Therefore, the user of the mobile originated device can transmit data according to the corresponding direction of the target mobile device but without realizing the identification name or the network address of the target mobile device, which can provide an easy way for users to transmit data.

In another embodiment of this invention, the user of the mobile originated device can select the target mobile device (step 720) through a user interface (such as a keyboard, a mouse, a Graphical User Interface or any other type of user interface). In other embodiments, the target mobile device can be selected (step 720) through other method, which should not be limited in this disclosure.

Above all, the resource of the mobile originated device for data transmission or pre-processing can be saved with assistance of the cloud server. Besides, since the datum is pre-processed according to the information of the target mobile device, the target mobile device can execute the pre-processed datum fluently.

Although the present invention has been described in considerable detail with reference to certain embodiments thereof, other embodiments are possible. Therefore, the spirit and scope of the appended claims should not be limited to the description of the embodiments contained herein. It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A data transmission system comprising:
a first wireless data transmission interface;
a second wireless data transmission interface;
a mobile originated device comprising:
a processing unit comprising:
a first obtaining module for obtaining information of at least one datum to be transmitted;
a selecting module for building connections with a plurality of candidate mobile devices through the first wireless data transmission interface, and selecting at least one target mobile device from the candidate mobile devices;
a second obtaining module for obtaining target-mobile-device information of the target mobile device through the first wireless data transmission interface; and
an information transmitting module for transmitting the target-mobile-device information and the information of the datum to be transmitted; and
at least one cloud server comprising:
a cloud-computing device comprising:
a connection-building module for building connections with the mobile originated device through the second wireless data transmission interface, receiving the target-mobile-device information and the information of the datum to be transmitted, and assisting the mobile originated device to transmit the datum to be transmitted to the target mobile device according to the target-mobile-device information and the information of the datum to be transmitted.

2. The data transmission system of claim 1, wherein the cloud-computing device further comprises:
a pre-processing module for pre-processing the datum to be transmitted according to the target-mobile-device information, and driving the mobile originated device to transmit the pre-processed datum to the target mobile device.

3. The data transmission system of claim 2, wherein:
the target-mobile-device information comprises at least one supported compression format of the target mobile device; and
the pre-processing module comprises:
a data compressor compressing the datum to be transmitted according to the supported compression format to pre-process the datum to be transmitted.

4. The data transmission system of claim 2, wherein:
the target-mobile-device information comprises a present bandwidth of the target mobile device; and
the pre-processing module comprises:
a data compressor for compressing the datum to be transmitted according to the present bandwidth to pre-process the datum to be transmitted.

5. The data transmission system of claim 2, wherein:
the target-mobile-device information comprises at least one supported data format of the target mobile device; and
the pre-processing module comprises:
a convertor for converting the datum to be transmitted according to the supported data format to pre-process the datum to be transmitted.

6. The data transmission system of claim 2, wherein the pre-processing module comprises:
an encryptor for encrypting the datum to be transmitted according to the target-mobile-device information to pre-process the datum to be transmitted.

7. The data transmission system of claim 1, wherein the mobile originated device further comprises:
a mobile storage unit electrically connected with the processing unit, wherein the mobile storage unit stores the datum to be transmitted.

8. The data transmission system of claim 1, wherein the target-mobile-device information comprises a cloud identification account of the target mobile device, the cloud server further comprises:
a cloud storage device comprising:
a storage space corresponding to the cloud identification account, wherein the datum to be transmitted is stored in the storage space, such that the target mobile device obtains the datum to be transmitted from the storage space utilizing the cloud identification account.

9. The data transmission system of claim 1, wherein the datum to be transmitted is stored in the cloud server, and the mobile originated device receives the datum to be transmitted from the cloud server through the second wireless data transmission interface according to the information of the datum to be transmitted and transmits the datum to be transmitted to the target mobile device through the first wireless data transmission interface.

10. The data transmission system of claim 1, wherein the cloud server builds connections with the target mobile device according to the target-mobile-device information, and transmits the datum to be transmitted to the target mobile device to assist the mobile originated device to transmit the datum to be transmitted to the target mobile device.

11. The data transmission system of claim 1, wherein:
the mobile originated device further comprises:
a transmission direction information generating unit electrically connected with the processing unit, wherein transmission direction information is generated through the transmission direction information generating unit; and
the processing unit further comprises:
an information receiving module for receiving candidate-mobile-device information of each of the candidate mobile devices from the candidate mobile devices through the first wireless data transmission interface; and
a direction-range calculating module for calculating transmission direction range according to the transmission direction information,
wherein the selecting module selects at least one of the candidate mobile devices, the candidate-mobile-device information of which matches the transmission direction range, wherein the selected at least one candidate device is taken as the target mobile device.

12. A data transmission method comprising:
obtaining information of at least one datum to be transmitted;
selecting at least one target mobile device from a plurality of candidate mobile devices;
obtaining target-mobile-device information of the target mobile device;
enabling a mobile originated device to transmit the target-mobile-device information and the information of the datum to be transmitted to a cloud server through a wireless data transmission interface; and
enabling the cloud server to assist the mobile originated device to transmit the datum to be transmitted to the target mobile device according to the target-mobile-device information and the information of the datum to be transmitted.

13. The data transmission method of claim 12 further comprising:
enabling the cloud server to pre-process the datum to be transmitted according to the target-mobile-device information.

14. The data transmission method of claim 13, wherein the step of making the cloud server pre-process the datum to be transmitted according to the target-mobile-device information comprises:
compressing the datum to be transmitted according to the target-mobile-device information to pre-process the datum to be transmitted.

15. The data transmission method of claim 14, wherein the target-mobile-device information comprises at least one supported compression format of the target mobile device or a present bandwidth of the target mobile device.

16. The data transmission method of claim 13, wherein the target-mobile-device information comprises at least one supported data format of the target mobile device, and the step of making the cloud server pre-process the datum to be transmitted comprises:
converting the datum to be transmitted according to the supported data format to pre-process the datum to be transmitted.

17. The data transmission method of claim 13, wherein the step of making the cloud server pre-process the datum to be transmitted comprises:
encrypting the datum to be transmitted according to the target-mobile-device information to pre-process the datum to be transmitted.

18. The data transmission method of claim 12, wherein the mobile originated device comprises a mobile storage unit, the datum to be transmitted is stored in the mobile storage unit, and the data transmission method further comprises:
obtaining the datum to be transmitted from the mobile storage unit according to the information of the datum to be transmitted.

19. The data transmission method of claim 12, wherein:
the target-mobile-device information comprises a cloud identification account of the target mobile device,
the cloud server comprises a cloud storage device, the cloud storage device comprises a storage space corresponding to the cloud identification account,
wherein the step of making the cloud server assist the mobile originated device to transmit the datum to be transmitted to the target mobile device according to the target-mobile-device information and the information of the datum to be transmitted comprises:
storing the datum to be transmitted into the storage space corresponding to the cloud identification account, such that the target mobile device obtains the datum to be transmitted from the storage space utilizing the cloud identification account.

20. The data transmission method of claim 12, wherein the datum to be transmitted is stored in the cloud server, and the step of making the cloud server assist the mobile originated device to transmit the datum to be transmitted to the target mobile device according to the target-mobile-device information and the information of the datum to be transmitted comprises:
enabling the mobile originated device to obtain the datum to be transmitted from the cloud server through the wireless data transmission interface according to the information of the datum to be transmitted; and
enabling the mobile originated device to transmit the datum to be transmitted to the target mobile device through the wireless data transmission interface or another wireless data transmission interface.

21. The data transmission method of claim 12, wherein the step of making the cloud server assist the mobile originated device to transmit the datum to be transmitted to the target mobile device according to the target-mobile-device information and the information of the datum to be transmitted comprises:
enabling the cloud server to build connections with the target mobile device according to the target-mobile-device information; and
transmitting the datum to be transmitted to the target mobile device to assist the mobile originated device to transmit the datum to be transmitted to the target mobile device.

22. The data transmission method of claim 12, wherein the step of selecting the target mobile device from the candidate mobile devices comprises:
obtaining candidate-mobile-device information of each of the candidate mobile devices from the candidate mobile devices;
generating direction information through the mobile originated device;
calculating transmission direction range according to the transmission direction information; and
selecting at least one of the candidate mobile devices, the candidate-mobile-device information of which matches the transmission direction range, wherein the selected at least one candidate device is taken as the target mobile device.
